(19) United States
(12) Patent Application Publication
(10) Pub. No.: US 2007/0021052 A1
(43) Pub. Date: Jan. 25, 2007

(54) Apparatus for interconnecting radios of different frequencies to provide a seamless communication system

(76) Inventor: Clarence L. Boice, San Carlos, CA (US)

Correspondence Address: JOHN S. HALE;GIPPLE & HALE, 6665-A OLD DOMINION DRIVE, MCLEAN, VA, 22101, US

(21) Appl. No.: 11/480,448

(22) Filed: Jul. 5, 2006

Related U.S. Application Data
(60) Provisional application No. 60/696,524, filed on Jul. 6, 2005.

(51) Int. Cl. H04H 1/00

(52) U.S. Cl. 455/3.01

(57) ABSTRACT

A communications network apparatus with a bank of a plurality of radios operating at different frequencies. At least one radio interface board is connected to the plurality of radios to convert analog signals from the radios into digital packets with an internet address and transmit the packets to an internet protocol router. The internet protocol router is dynamically programmable by a touch screen monitor so that it receives the digital packets and delivers the packets to selected interconnected users. Each interconnected user can be selected by a third party to talk and/or listen to other users in the interconnected group.

### RELATED APPLICATIONS

This application claims the benefit of Provisional Application No. 60/696,524, filed Jul. 6, 2005.

### STATEMENT REGARDING FEDERALLY SPONSORED RESEARCH OR DEVELOPMENT

Not applicable.

### REFERENCE TO SEOUENCE LISTING. A TABLE OR A COMPUTER PROGRAM LISTING COMPACT DISC APPENDIX

None.

### FIELD OF INVENTION

The present invention is generally directed toward an apparatus for interconnecting radios of different types which operate at different frequencies to provide a seamless operable communication system.

### BACKGROUND OF THE INVENTION

This invention generally relates to the current problem of radio interoperability within the United States. Emergency response organizations, such as the fire department, hazmat units, police, National Guard, Homeland Security and other organizations generally cannot talk to each other because they all use different radios operating on different frequency bands. All states have established a statewide emergency operations center and a significant percentage have developed mutual assistance agreements with neighboring states for sharing National Guard resources, equipment and personnel. Only a small percentage of states, less than 25%, have developed statewide interoperability; namely the ability for emergency responders to communicate with one another during an incident and it is acknowledged that this operability between emergency responders is a top priority and currently presents many problems.

Various companies have approached this problem by designing a universal radio, namely one that is capable for handling all frequencies. However the serious limitation of this approach lies in the prohibitive expense, in that all emergency responders would have to replace radios that they already have along with additional training costs.

The present apparatus is an extremely versatile software-based digital communications system, capable of capturing and delivering real-time actionable intelligence (including video and digital data) from the forward edge of any emergency situation or event. It is equipped with a versatile and complete radio interoperability system. The apparatus has the ability to create, remotely administer, and dynamically allocate talk/listen groups with radio-based communication systems, from the first responder 800 MhZ and 700 MhZ legacy radios, through the entire spectrum of VHF, UHF, Marine Band, Citizen's Band, Family Band, and Cell Phone frequencies. The ICU can reach back to the command operations center within seconds, providing the incident commander with a set of realtime eyes and ears on the ground.

1. Field of the Invention

The present invention relates to an apparatus which allows seamless communications between emergency responders and governmental authorities using different radio and communication equipment which operate on different frequencies.

2. Discussion of the Prior Art

One solution, pursued by Motorola, is to rebuild the country's communication infrastructure, setting up massive, new networks and providing interfaces as required to enable user radios to communicate with the network.

Another approach to this problem has been provided from Raytheon which has developed a product that provides an equipment bank of radios which is capable of setting up a conversation between anyone using one of the Raytheon radios in their system. This implementation is very expensive and too limited in function.

It can thus be seen that there is a need for a system which allows multiple users having existing different radios and communication devices to communicate and/or listen within a designated communication network.

### SUMMARY OF THE INVENTION

The communication apparatus provides a versatile software-based digital communications system, capable of capturing and delivering real-time actionable data including video and digital data from the forward edge of any emergency event. The communication apparatus has the ability to create, remotely administer and dynamically allocate talk/listen groups with all radio based communication systems from the first responder, 800 MhZ and 700 MhZ legacy radios through the entire spectrum of VHF, UHF, Marine Band, Citizen's Band, Family Band and cell phone frequencies allowing reach back to the command operations center within seconds and providing the incident commander with a set of real time eyes and ears on the ground. The inventive apparatus which takes the analog signals from different radios and digitizes the signals into an IP packet with an address. The various packets are directed by a programable router to predesignated parties for complete communication or listen only mode allowing all parties to use their original radio equipment.

It is an object of the invention to provide a system to provide communication between multiple parties using different radio equipment operating on different frequencies.

It is another object of the invention is that it may be used with commercially available radios, switches, monitors and software.

It is yet another object of the invention to allow emergency communications to be carried out using services and equipment commercially available and used in the majority of countries and regions of the world.

It is still another object of the invention to use existing satellite communications and Internet technologies, such as TCP/IP protocol communications via the Internet, which enables real time communications to be implemented economically, using low cost and readily available hardware and software technology.

It is yet another object of the invention to provide connectivity with legacy and existing radio networks.

It is another object of the invention to provide for a communication system which has satellite reach back and legacy connection.

It is still another object of the invention to provide a communication system which has dynamic allocations of talk/listen groups.

It is yet another object of the invention to provide a communication system having video and digital data capabilities.

It is another object of the invention to provide a communication system which allows remote administration of talk/listen groups.

It is still another object of the invention to provide for a communication system which is user friendly and can be operated with a minimum of skill and training

### BRIEF DESCRIPTION OF THE DRAWINGS

FIG. 1 is a schematic block diagram of the inventive interconnecting multiple radio communications system;

FIG. 2 is a blowup of the touch screen user interface control monitor display showing talk groups and equipment connections;

FIG. 3 is representation of the touch screen shown in FIG. 2 showing a three member scenario in a block diagram inclusion including a satellite, Radio 7 and Radio 10 interface;

FIG. 4 is representation of the touch screen shown in FIG. 2 showing a six member scenario in a block diagram inclusion including Radio 1, Radios 3-5 and Radios 9 and 10 interface;

FIG. 5 is representation of the touch screen shown in FIG. 2 showing a three member scenario in a block diagram inclusion including Radio 2, Radio 8 and Radio 10 interface;

FIG. 6 is representation of the touch screen shown in FIG. 2 showing a Radio 6 broadcast to all talk groups and Radio 10 interface in a block diagram inclusion;

FIG. 7 is representation of the touch screen interface shown in FIG. 2 showing Radio 10 listening to all talk groups in a block diagram inclusion;

FIG. 8 is representation of the touch screen interface shown in FIG. 2 showing Radio 4 listening to audio traffic on TG1 And TG4; and

FIG. 9 is a schematic legend showing the listen only mode, talk only mode and talk and listen mode for each two segment touch area.

These and other objects, advantages, and novel features of the present invention will become apparent when considered with the teachings contained in the detailed disclosure along with the accompanying drawings.

### DESCRIPTION OF THE INVENTION

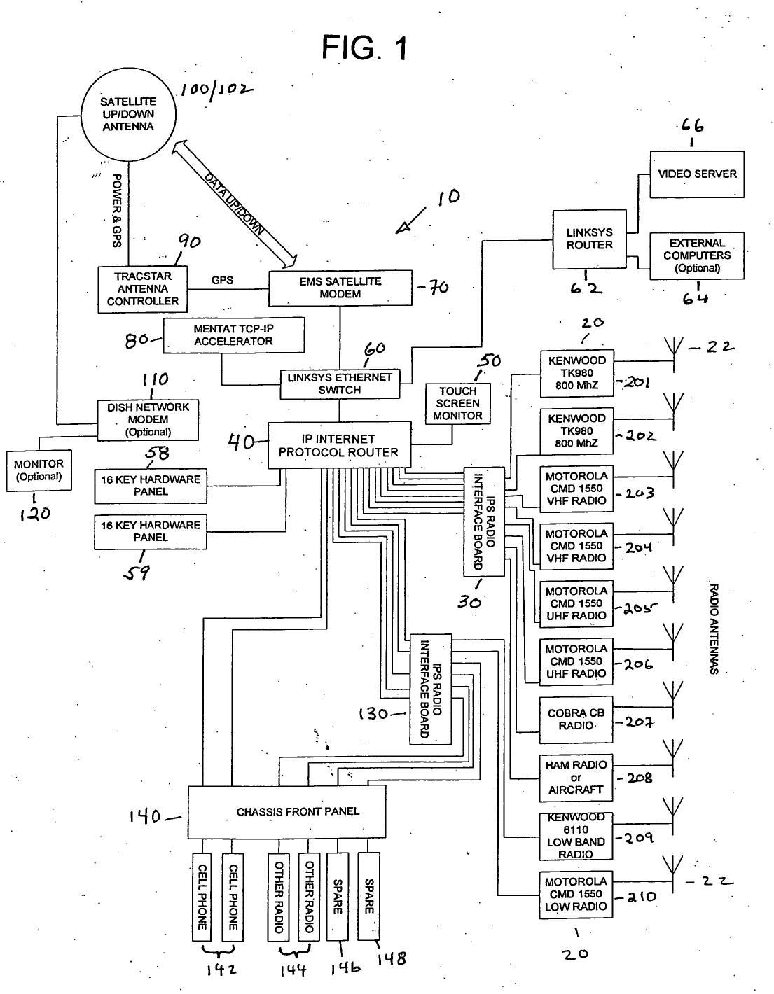

While the present invention is susceptible of embodiment in various forms as is shown in the drawings, and will hereinafter be described, a presently preferred embodiment is set forth with the understanding that the present disclosure is to be considered as an exemplification of the invention, and is not intended to limit the invention to the specific embodiments disclosed herein. The preferred embodiment and best mode of the invention for these purposes is shown in FIGS. 1 through 9.

The present communication apparatus 10 is assembled with a bank of different radios 20 having antennas 22 which are connected to an IPS interface board 30. The IPS interface board 30 converts the analog signal received by each respective radio 201 to 210 as shown in FIG. 1 and converts the signal into IP packets, namely it takes a traditional radio signal regardless of the frequency from a source radio which is the same as one of the radios in the bank of radios and provides an internet address protocol to that radio signal. FIG. 1 shows ten radios in the radio bank namely; Kenwood TK980 800 MhZ Radios (201 and 202), Motorola CMD 1550 VHF Radios (203 and 204), Motorola CMD 1550 UHF Radios (205 and 206), Cobra CB Radio (207), Ham or Aircraft Radio (208), Kenwood 6110 Low Band Radio (209) and Motorola CMD 1550 Low Band Radio (210). Each radio has an IP address. The IP packets are transmitted from the IPS interface board 30 to an IP internet protocol router 40 which directs the packet and IP address (who from and where it is supposed to go). The signal traffic is processed using the same packet switching technology of the internet. Thus the communication apparatus plugs directly into the internet via a standard Ethernet connection.

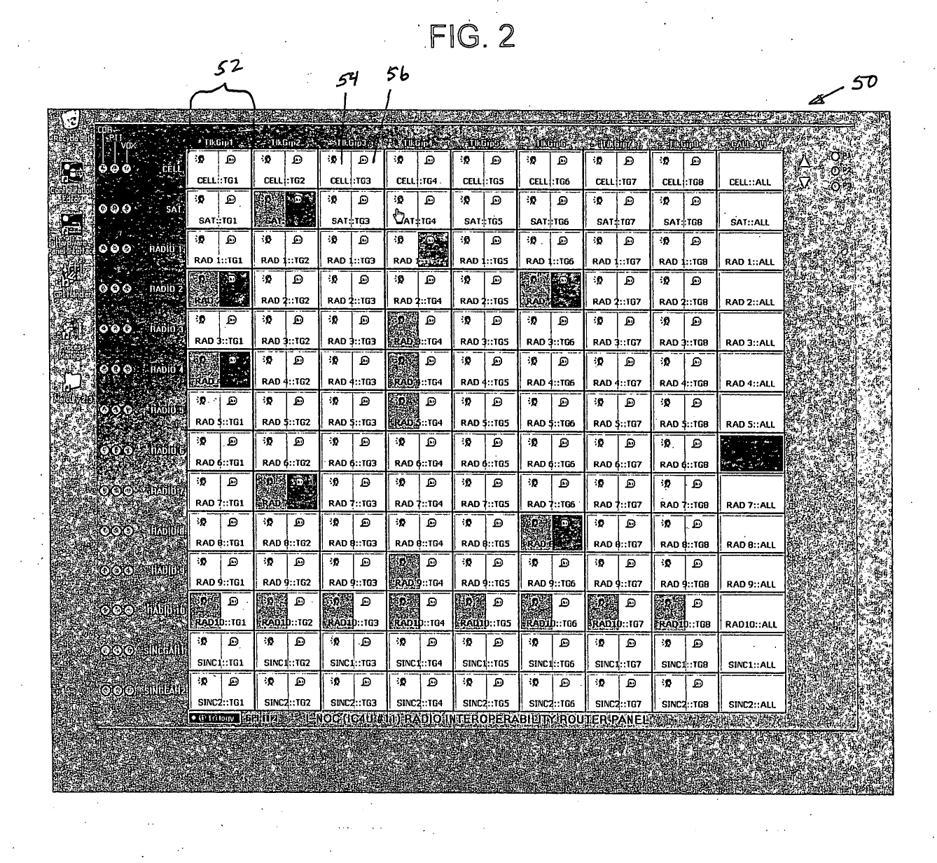

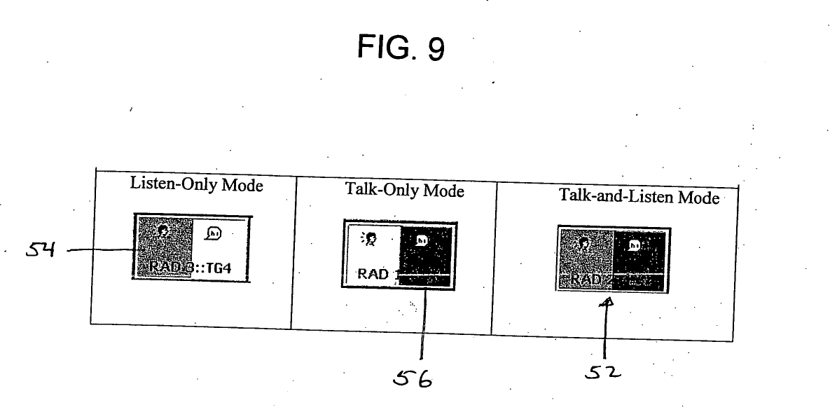

The IP internet protocol router 40 is a programmable router and is controlled by touch screen monitor 50 which has a user interface and user friendly menus with a touch screen which has horizontal and vertical laser beams to determine the touch area The touch screen monitor 50 is shown in FIG. 2 and is provided with cell phone, satellite, radio and singcar touch areas on the horizontal axis and corresponding talk group and call all touch areas on the horizontal axis. Each touch area 52 as best shown in FIG. 9 is provided with two sections, a listen only mode 54 positioned on the left side and a talk only mode 56. Each touch area mode has to be separately touched to be activated and when the listen only mode 54 is touched and the talk only mode 56 is touched, both the talk and listen mode are activated. These various modes of communication are shown in FIG. 9. The software operating system for the screen 50 is WINDOWS by Microsoft. Thus the touch screen allows dynamic programming of users showing the user matrix and constantly shows which users are active. The monitor 50 is also provided with a cursor which can be moved with a standard mouse to activate specific screen touch area locations to also provide respective users with talk and receive or receive capabilities. Inside the computer, as controlled by software, the multiple radio signals can be set up into “talk groups” in unlimited ways. Using the touch screen video monitor control panel, the system operator can configure “push-to-talk conversations between the operator and any hand-held radios within signal range. Conversations can uniquely be set in any of the various modes referred to as “one to one”, “one to many” or “many to many” The system operator has complete flexibility in the establishment of multiple, simultaneous conversations. It is not sufficient to enable everyone to be able to talk to each other. It is also important for the system operator to be able to control who can talk and who cannot—otherwise, as experience has proven one ends up with a “tower of babble”, which creates problems in emergency situation involving multiple groups and when command and control is critical. The operator can designate any conversation participant to have talk and listen or listen only privileges.

The IP internet router 40 is also connected to two key hardware panels 58 and 59 which can be preprogrammed for various groups of users with push key line interviews.

The IP internet protocol router 40 is connected to an ethernet switch 60 such as that manufactured by LINKSYS for satellite interface. The ethernet switch 60 is connected to a satellite modem 70 such as that manufactured by EMS for receiving data and transmitting data to the satellite and is also connected to a TCP-IP accelerator 80 such as that manufactured by MENTAT to compensate for the 600 millisecond delay in satellite transmissions. In effect, the TCP-IP accelerator 80 says to the router 40 that there is no delay in audio/TV transmissions and receives the benefit of the input speed of internet connection by satellite by 100× on large bit transfers while it continues to send back I am alive signals.

The Ethernet switch 60 is also connected to a router 62 which can optionally transmit the data to external computers 64 for further processing or a video server 66.

The satellite modem 70 is also connected to an auto-positioning antenna 90 such as that manufactured by TRACSTAR for satellite reach back ability to position the satellite 100 up/down antenna 102. With the mobile satellite up/down link, the system operator is provided with a satellite internet interface. Not only can the system operator connect to the internet the same as any conventional office computer, the operator can do so as long as he or she has an unobstructed view of the satellite which as a practical matter is virtually everywhere in the continental United States and most places in the world. This enables any radio communication received by the system to be transmitted/received over the internet so that the system operates in or with remote locations where normal internet connection is either not available or has become disabled. The system includes an optional commercial satellite TV modem 110 such as that manufactured by DISH NETWORKS so that the users connected on the communication system can watch news channels to see what is happening real time. The commercial satellite TV modem 110 is connected to a monitor 120.

A second IPS radio interface board 130 which operates like IPS interface board 30 is connected to additional radios and equipment via chassis front panel 140. The front panel 140 is also connected to additional cell phones 142, other radios 144 and spare units such as a digital radio 146 and a low band width video 148.

It will be apparent that transmission to each individual user radio and cell phone is reversed as each radio has an IP address and the IP packets are converted by IPS interface boards 30, 130 and front panel 140 from digital signals to analog signals for reception by each respective radio/cell phone at the user location. One of the concepts of the present system is that it digitizes the audio output of each one of the multiple radios in the equipment rack and then manipulates the audio streams inside a computer. Because virtually every hand held radio in use today has an audio output, the bank of radios includes a transceiver that will enable the computer to talk with virtually any radio and on all frequencies in existence.

Another function is that the systems tracking antenna system also supports the transmission/reception of streaming videos, thus enabling field cameras to send/receive live video from/to command headquarters or anywhere within the reach of the communication satellites or the internet.

The present invention supports seamless communications between all parties or selected parties as shown by the following examples:

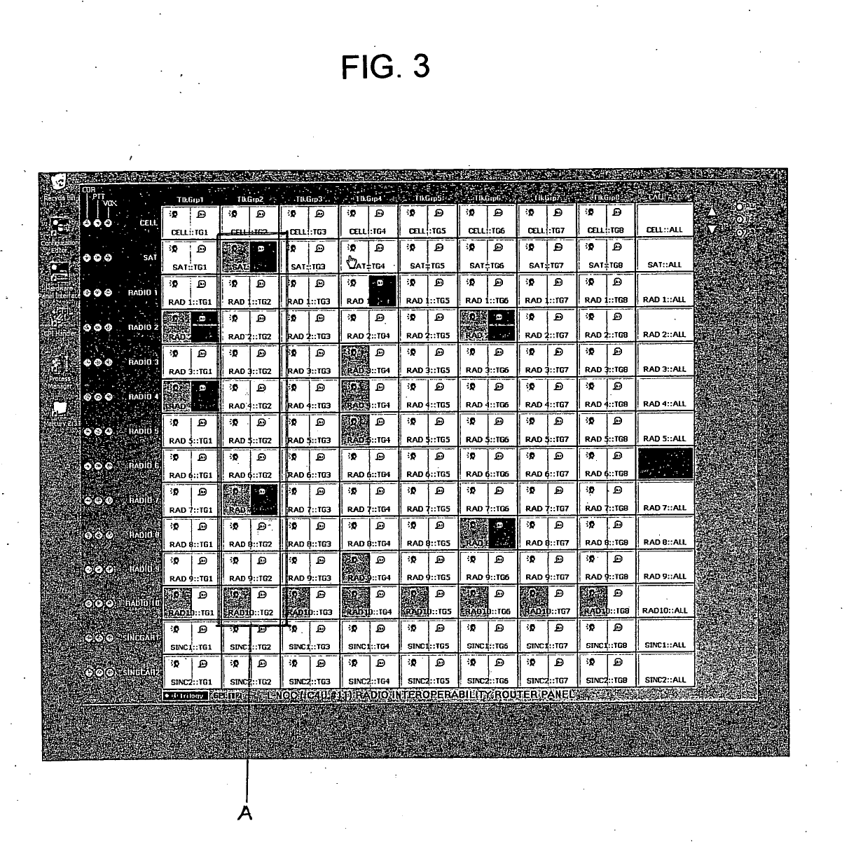

Example 1 as shown in FIG. 3 has the capability of using one or more of the 8 Talk Groups which are set up for the router panel—Talk Group 1 (TG1) through Talk group 8 (TG8). As shown in FIG. 3, block A TG2 has three members; Satellite, Radio 7 and Radio 10. In this example satellite can talk to Radio 7 and radio 10; Radio 7 can talk to Satellite and Radio 10 and Radio 10 can only listen to Satellite and Radio 7.

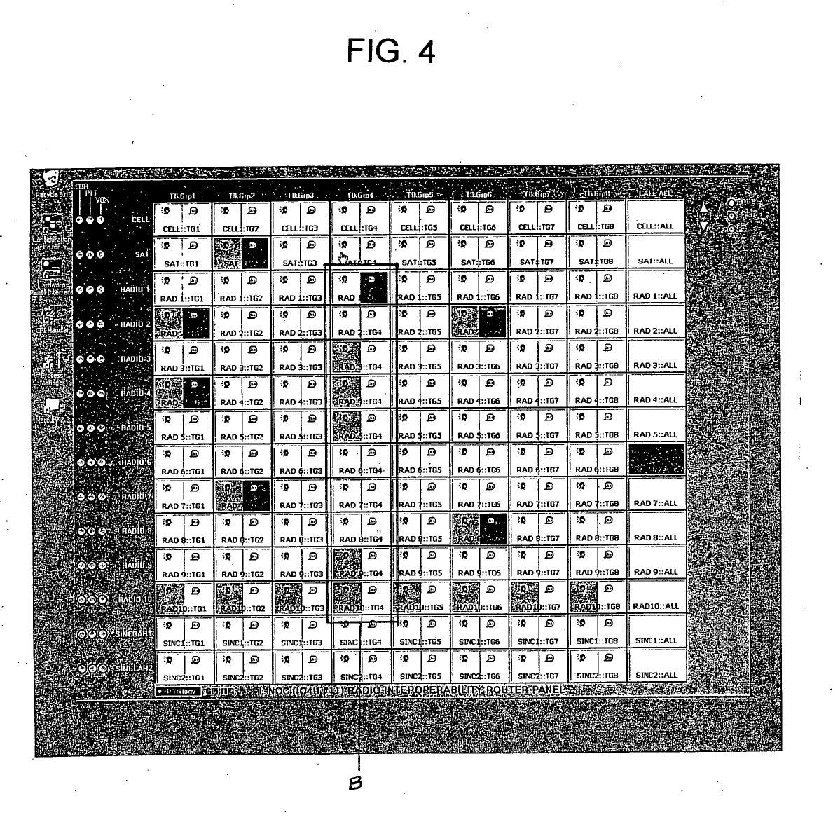

Example 2 as shown in FIG. 4 has the capability of using one or more of the 8 Talk Groups which are set up for the router panel—Talk Group 1 (TG1) through Talk group 8 (TG8). As shown in FIG. 4, block B TG4 has six members; Radio 1, Radios 3-5 and Radios 9, 10. In this example Radio 1 talks to all Radios in the groups. Radios 3-5, 9,10 can only listen to audio traffic on TG4

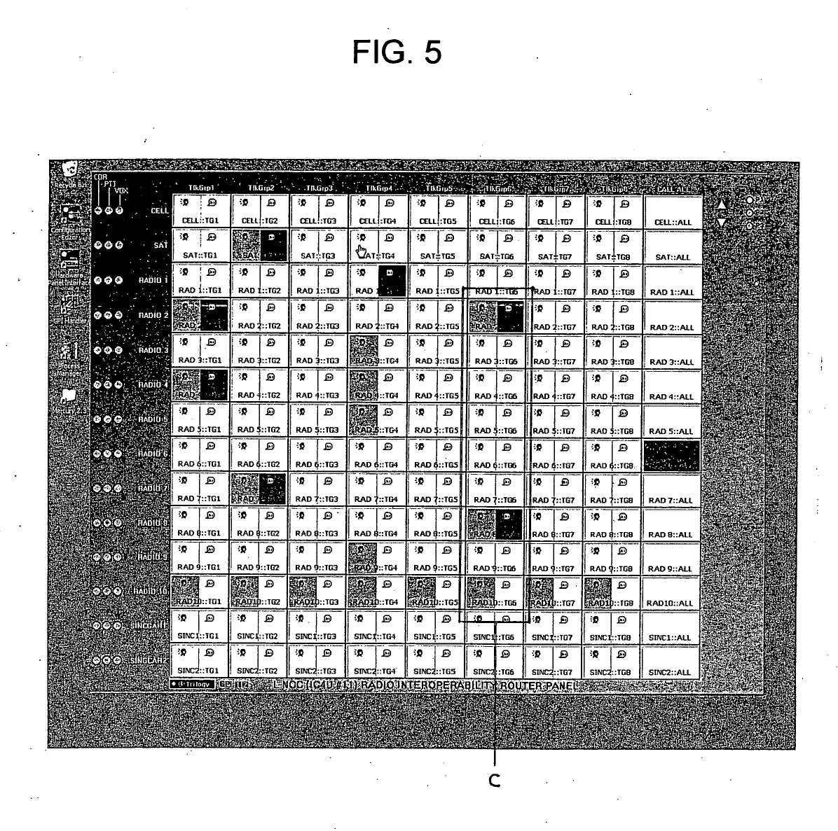

Example 3 as shown in FIG. 5 has the capability of using one or more of the 8 Talk Groups which are set up for the router panel—Talk Group 1 (TG1) through Talk group 8 (TG8). As shown in FIG. 5, block C TG6 has three members; Radios 2, 8 and Radio 10. In this example both Radios 2 and 8 can talk and listen on TG6 while Radio 10 can only listen to TG6.

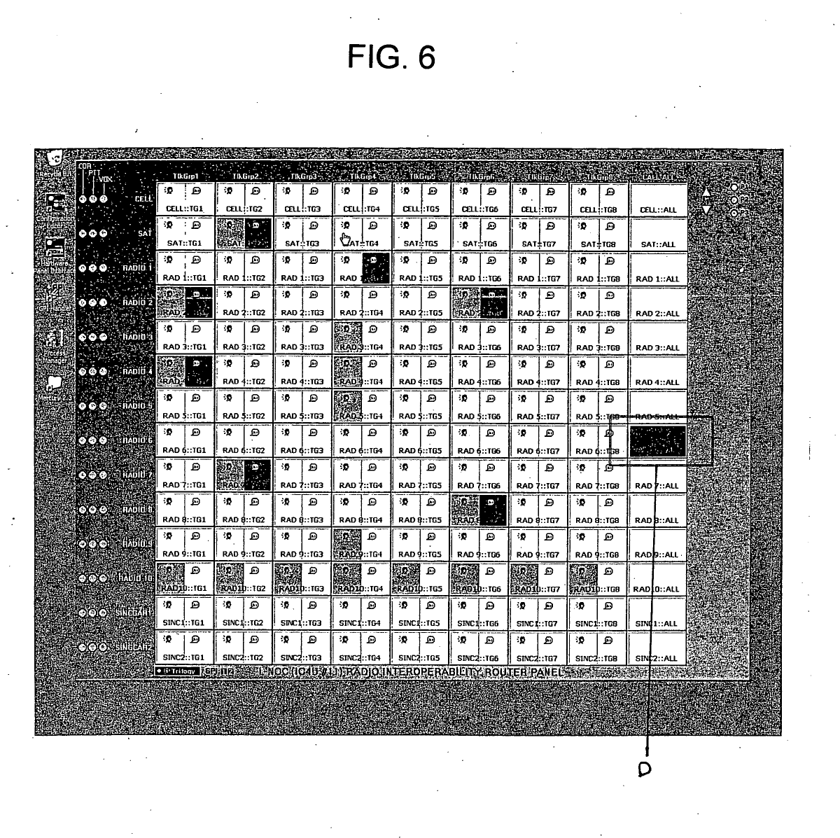

Example 4 as shown in FIG. 6 has the capability of using one or more of the 8 Talk Groups which are set up for the router panel -Talk Group 1 (TG1) through Talk group 8 (TG8). As shown in FIG. 6, block D Radio 6 can talk or broadcast to All Talk Groups.

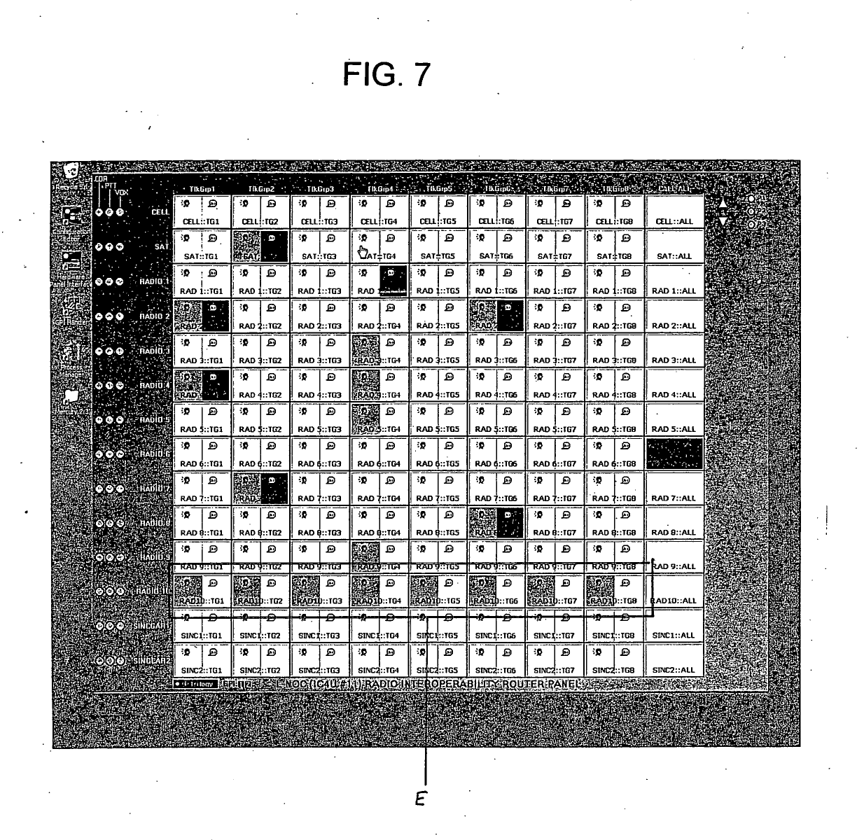

Example 5 as shown in FIG. 7 has the capability of using one or more of the 8 Talk Groups which are set up for the router panel—Talk Group 1 (TG1) through Talk group 8 (TG8). As shown in FIG. 7, block E Radio 10 can only listen to All Talk Groups.

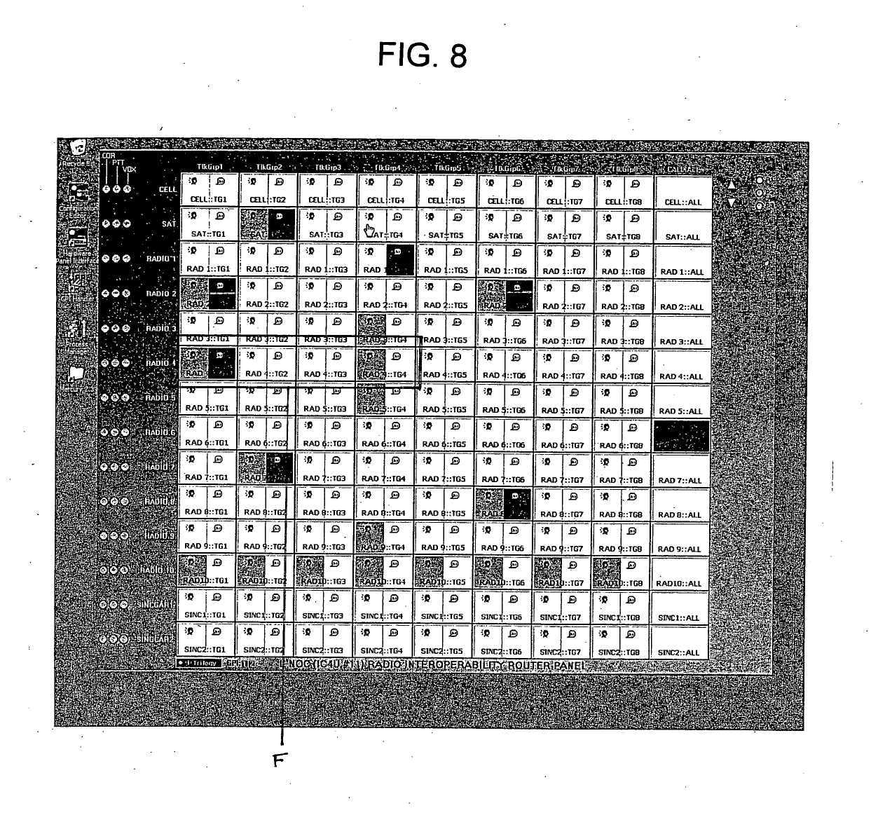

Example 6 as shown in FIG. 8 has the capability of using one or more of the 8 Talk Groups which are set up for the router panel—Talk Group 1 (TG1) through Talk group 8 (TG8). As shown in FIG. 8, block F Radio 4 listens to audio traffic on TG1 and TG4 and can only talk to TG1.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A communications network apparatus comprising a bank of a plurality of different radios operating on different frequencies, means to change radio transmissions received by each of said radios into a digital packet with an internet address and transmit said packet to an internet protocol router, said internet protocol router being dynamically programmable by a monitor with a selection screen and adapted to receive said digital packets and transmit said packets to a selected group of interconnected users having radios with a frequency corresponding to at least one of said bank of radios allowing said interconnected users to selectively talk and/or listen to other users in the interconnected group.

2. A communications network apparatus as claimed in claim 1, wherein said monitor is a touch screen monitor divided into segments representing the radios and a plurality of talk groups.

3. A communications network apparatus as claimed in claim 2 wherein each segment comprises a talk only portion and a listen only portion which have to be selectively engaged to be activated.

4. A communications network apparatus as claimed in claim 2 wherein monitor shows a matrix and shows which user is active.

5. A communications network apparatus as claimed in claim 1, wherein said apparatus includes an ethernet switch connected to said internet protocol router, said ethernet switch being connected to a satellite modem to transmit data and receive data from a satellite.

6. A communications network apparatus as claimed in claim 1, including at least one key hardware panel connected to said internet protocol router for key programming of said router.

7. A communications network apparatus as claimed in claim 1 wherein said radios operating at different frequencies are taken from a group consisting of 800 MhZ and 700 MhZ legacy radios, VHF, UHF, Low Band and Low Radio.

8. A communications network apparatus as claimed in claim 1 wherein said radios operating at different frequencies are taken from a group consisting of 800 MhZ and 700 MhZ, 800 MhZ and 700 MhZ legacy radios, VHF, UHF, Low Band and Low Radio, Citizen's Band, Family Band, Marine Band, Cell Phone and digital radios.

9. A communications network apparatus as claimed in claim 1 wherein said means to change radio transmissions into digital packets with an internet address comprise at least one radio interface board connected to a plurality of radios to convert analog signals from said radios to digital packets with an internet address.

10. A communications network apparatus comprising a bank with a plurality of radios operating at different frequencies, at least one radio interface board connected to a plurality of radios to convert analog signals from said radios into digital packets with an internet address and transmit said packets to an internet protocol router, said internet protocol router being dynamically programmable by a touch screen monitor so that it receives said digital packets and delivers said packets to selected interconnected users, each interconnected user being selected by a third party to talk and/or listen to other users in the interconnected group.

11. A communications network apparatus as claimed in claim 10 wherein said radios operating at different frequencies are taken from a group consisting of 800 MhZ and 700 MhZ 700 radios, VHF, UHF, Low Band and Low Radio.

12. A communications network apparatus as claimed in claim 10 wherein said radios operating at different frequencies are taken from a group consisting of 800 MhZ and 700 MhZ radios, 800 MhZ and 700 MhZ legacy radios, VHF, UHF, Low Band and Low Radio, Citizen's Band, Family Band, Marine Band, Cell Phone and digital radios.

13. A communications network apparatus as claimed in claim 10 wherein said apparatus includes an ethernet switch connected to said internet protocol router, said ethernet switch being connected to a satellite modem to transmit data and receive data from a satellite.

14. A communications network apparatus as claimed in claim 10 wherein said monitor is a touch screen monitor divided into segments representing the radios and a plurality of talk groups.

15. A communications network apparatus as claimed in claim 14 wherein each segment comprises a talk only portion and a listen only portion which have to be selectively engaged to be activated.

16. A communications network apparatus comprising a bank having a plurality of different radios operating on different frequencies taken from a group consisting of 800 MhZ and 700 MhZ radios, 800 MhZ and 700 MhZ legacy radios, VHF, UHF, Low Band and Low Radio, Citizen's Band, Family Band, Marine Band, Cell Phone and digital radios, means to change radio transmissions received by each of said radios into digital packets with an internet address and transmit said packets to an internet protocol router, said internet protocol router being dynamically programmable by a touch screen monitor with a selection screen divided into segments representing a plurality of talk groups, each segment comprising a talk only portion and a listen only portion which have to be selectively engaged to be activated, said internet protocol router being adapted to receive said digital packets and transmit said packets to a selected group of interconnected users having radios with a frequency corresponding to at least one of said bank of radios allowing said interconnected users to selectively talk and/or listen to other users in the interconnected group, and an ethernet switch connected to said internet protocol router, said ethernet switch being connected to a satellite modem to transmit data and receive data from a satellite.

17. A communications network apparatus as claimed in claim 16, including at least one key hardware panel connected to said internet protocol router for key programming of said router.

18. A communications network apparatus as claimed in claim 16 wherein said means to change radio transmissions into digital packets with an internet address comprise at least one radio interface board connected to said plurality of different radios to convert analog signals from said radios to digital packets with an internet address.

19. A communications network apparatus as claimed in claim 18 wherein said bank of different radios have antennas which are radio interface board based.

20. A communications network apparatus as claimed in claim 16 wherein said touch screen monitor shows which users are active and is also provided with a cursor moved by a mouse to activate specific screen touch areas.
